(19) United States
(12) Patent Application Publication
(10) Pub. No.: US 2015/0178776 A1
(43) Pub. Date: Jun. 25, 2015

(54) CUSTOMIZING ADVERTISEMENT IN A MOBILE ENVIRONMENT

(71) Applicant: Empire Technology Development LLC, Wilmington, DE (US)

(72) Inventors: Juanqin Li, Beijing (CN); Qi Li, Beijing (CN); Xuefeng Song, Hebei (CN)

(21) Appl. No.: 14/409,280

(22) PCT Filed: Apr. 19, 2013
(86) PCT No.: PCT/CN2013/074434

§ 371 Date: Dec. 18, 2014

(51) Int. Cl. G06Q 30/02; H04M 1/725

(52) U.S. Cl. CPC G06Q 30/0257; G06Q 30/0267; H04M 1/72583

(57) ABSTRACT

In one example, an apparatus includes a display component configured to display a series of advertisements, and an interactive component that detects one or more user interactions, and removes a displayed one of the advertisements from the display component in response to at least one of the one or more user interactions.

### TECHNICAL FIELD

The embodiments described herein pertain generally to removing unwanted advertisements displayed on a mobile device, and customizing mobile advertising based on a user's actions within the mobile device.

### BACKGROUND

Advertising in a mobile environment has developed rapidly in recent years. Graphic and text advertisements presented to a user, via mobile devices, are ubiquitous. Screen sizes of mobile devices are typically small enough that displayed advertisements may disturb a user's viewing experience during execution of one or more mobile applications on the mobile device. A user typically removes an advertisement by closing the advertisement through clicking a close button on the advertisement. Since the user may find these advertisements annoying, a marketing effect of the advertisements is decreased.

### SUMMARY

In one example embodiment, an apparatus is provided that may comprise a display component configured to display a series of advertisements, and an interactive component configured to detect one or more user interactions and to remove a displayed one of the advertisements from the display component in response to at least one of the one or more user interactions.

In another example embodiment, a method is provided that may comprise displaying a series of advertisements, and removing at least one of the series of advertisements in response to at least one of one or more user interactions, wherein at least one of the one or more user interactions includes rubbing across the displayed one of the advertisements.

In yet another example embodiment, a computer-readable medium is provided storing instructions that, when executed, may cause one or more processors to perform operations comprising displaying an advertisement, and removing the advertisement in response to a user interaction with a device on which the computer-readable medium is hosted.

In yet another example embodiment, a system is provided that may comprise a server configured to maintain an advertisement database; and a device, communicatively connected to the server, configured to display a series of advertisements that are removable in response to one or more of a plurality of user interactions.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

In the detailed description that follows, embodiments are described as illustrations only since various changes and modifications will become apparent to those skilled in the art from the following detailed description. The use of the same reference numbers in different figures indicates similar or identical items.

FIG. 1 shows an example system configuration in which customizing advertisements in a mobile environment may be implemented, arranged in accordance with at least some embodiments described herein;

FIG. 2 shows an example configuration of a client application by which at least portions of customizing advertisements in a mobile environment may be implemented, arranged in accordance with at least some embodiments described herein;

FIG. 3 shows an example configuration of an advertisement provider by which at least portions of customizing advertisements may be implemented, arranged in accordance with at least some embodiments described herein;

FIG. 4 shows an example configuration of a processing flow of operations for performing at least portions of customizing advertisements by a client application, in accordance with at least some embodiments described herein;

FIG. 5 shows an example processing flow of operations for performing at least portions of customizing advertisements by an advertisement provider, in accordance with at least some embodiments described herein; and

FIG. 6 shows a block diagram illustrating an example computing device by which various example solutions described herein may be implemented, arranged in accordance with at least some embodiments described herein.

### DETAILED DESCRIPTION

In the following detailed description, reference is made to the accompanying drawings, which form a part of the description. In the drawings, similar symbols typically identify similar components, unless context dictates otherwise. Furthermore, unless otherwise noted, the description of each successive drawing may reference features from one or more of the previous drawings to provide clearer context and a more substantive explanation of the current example embodiment. Still, the example embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein and illustrated in the drawings, may be arranged, substituted, combined, separated, and designed in a wide variety of different configurations, all of which are explicitly contemplated herein.

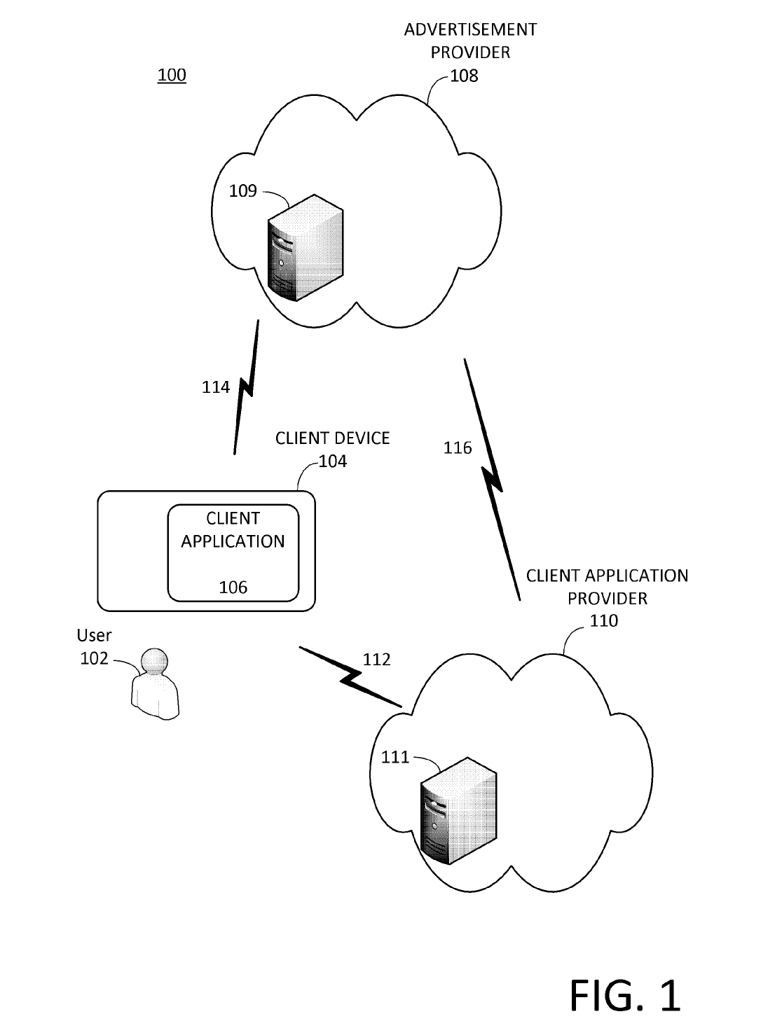

FIG. 1 shows an example system configuration 100 in which customizing advertisements in a mobile environment may be implemented, arranged in accordance with at least some embodiments described herein. As depicted, configuration 100 includes, at least, a client device 104 with an instance of a client application 106 hosted thereon, an advertisement provider 108, a server 109 hosted by advertisement provider 108, a client application provider 110, and a server 111 hosted by client application provider 110. A user 102 may be regarded as a person that exercises ownership or control of client device 104.

Client device 104 may refer to a processor-based electronic device on which an instance of client application 106 may be hosted to implement various embodiments of customizing advertisements in a mobile environment, on client device 104. Further, client device 104 may be configured to transmit and receive data over a communication link to advertisement provider 108 by further connecting to a mobile communications network provided by a wireless service provider (not shown). Client device 104 may be implemented as a mobile (or portable) electronic device such as a mobile phone, cell phone, smartphone, personal data assistant (PDA), a personal media player device, an application specific device, or a hybrid device that includes any of the above functions. Client device 104 may also be implemented as a personal computer including tablet, laptop computer, and non-laptop computer configurations, which may be connected to the aforementioned mobile communications network or, alternatively, to a wired network.

The aforementioned wireless service provider for implementing communications for client device 104 may also be known as a mobile network carrier, wireless carrier, or even cellular company. Regardless of the alternate reference, the wireless service provider may provide services for mobile communications subscribers. Client device 104 may be configured to communicate with at least one of advertisement provider 108 and client application provider 110, both of which may similarly communicate with each other. Further, client device 104 may be configured to communicate with advertisement provider 108 and/or client application provider 110 directly in a peer-to-peer networking environment.

Client application 106 may refer to a program implemented by hardware, software, firmware, or any combination thereof that may be utilized to customize advertisements from client device 104. Client application 106 may be included in or otherwise integrated with software (not shown) in order to implement customizing advertisements in a mobile environment. That is, client application 106 hosted on client device 104 may enable client device 104 to receive desirable mobile advertising as well as also selectively remove unwanted advertisements. For example, client application 106 may interpret various user interactions with client device 104, e.g., rubbing a display thereof, user keystrokes and/or various forms of user action or activity on client device 104, etc., and, based on the user interactions, remove at least a currently displayed advertisement.

Client application 106 may facilitate user interaction with advertisement provider 108. For example, client application 106 may be configured, designed, and/or programmed to retrieve and store user action information pertaining to actions performed by user 102 interactively with client device 104, and to transmit the user action information to advertisement provider 108. At advertisement provider 108, an advertisement database may be searched for advertisements that may be related to the user action information. Matching advertisements may be retrieved and transmitted to client device 104 for display to user 102. For example, when user 102 performs searches via client device 104 pertaining to automobiles, automobile advertisements may be displayed to user 102 via client device 104. According to one or more embodiments, client application 106 may be provided by client application provider 110.

Further, client application provider 110 may be configured, designed, and/or programmed to tailor and/or update client application 106 to perform functions e.g., retrieval of specific user action information based on changes or updates in advertisement retrieval algorithm and/or other instructions within advertisement provider 108.

Further, at least some embodiments of removing advertisements in a mobile environment may contemplate client application 106 implemented as a web browser that is configured to facilitate user interaction with advertisement provider 108.

Advertisement provider 108 may be regarded as a cloud-based service and storage platform owned and/or operated by a third-party service provider. Advertisement provider 108 may include a framework of hardware, software, firmware, or any combination thereof, through or to which digital advertisement data and information may be stored, passed, or shared for which client device 104, is a recipient. More particularly, advertisement provider 108 may be implemented as a web-based storage and sharing service.

Server 109 may refer to one or more servers hosted by, or corresponding to, advertisement provider 108, which may be configured to store advertisements, and utilize at least one advertisement retrieval algorithm or other instructions to retrieve advertisements based on user action information and user interaction information. Although one server is shown in FIG. 1, server 109 may refer to more than one server.

Client application provider 110 may be configured, designed and/or programmed to provide at least one client application 106 to client 104 and data and services to client application 106. Client application provider 110 may include a framework of hardware, software, firmware, or any combination thereof, through or to which client applications may be stored, passed, or shared for which client device 104, is a recipient.

Server 111 may refer to one or more servers hosted by, or corresponding to, client application provider 110, which may be configured to provide client application 106. Although one server is shown in FIG. 1, server 111 may refer to more than one server.

Communication link 112 may refer to a communication link enabled by a protocol utilized to transmit client application 106 to client device 104.

Communication link 114 may refer to a communication link enabled by a protocol utilized to transmit data and/or information between client application 106, via client device 104, and advertisement provider 108.

Communication link 116 may refer to a communication link enabled by a protocol utilized to transmit data and/or information between client application provider 110 and advertisement provider 108.

The aforementioned protocols referring to communication links 112 and 114 may include any mobile communications technology, e.g., GSM, CDMA, etc., depending upon the technologies supported by particular wireless service providers to whose services client device 104, advertisement provider 108 and client application provider 110 may be assigned or subscribed. Further, one or more of the aforementioned communication links 112 and 114 may be implemented utilizing non-cellular technologies such as conventional analog AM or FM radio, Wi-Fi™, wireless local area network (WLAN or IEEE 802.11), WiMAX™ (Worldwide Interoperability for Microwave Access), Bluetooth™, hard-wired connections, e.g., cable, phone lines, and other analog and digital wireless voice and data transmission technologies.

Thus, FIG. 1 shows an example implementation of a system configuration for implementing mobile advertising.

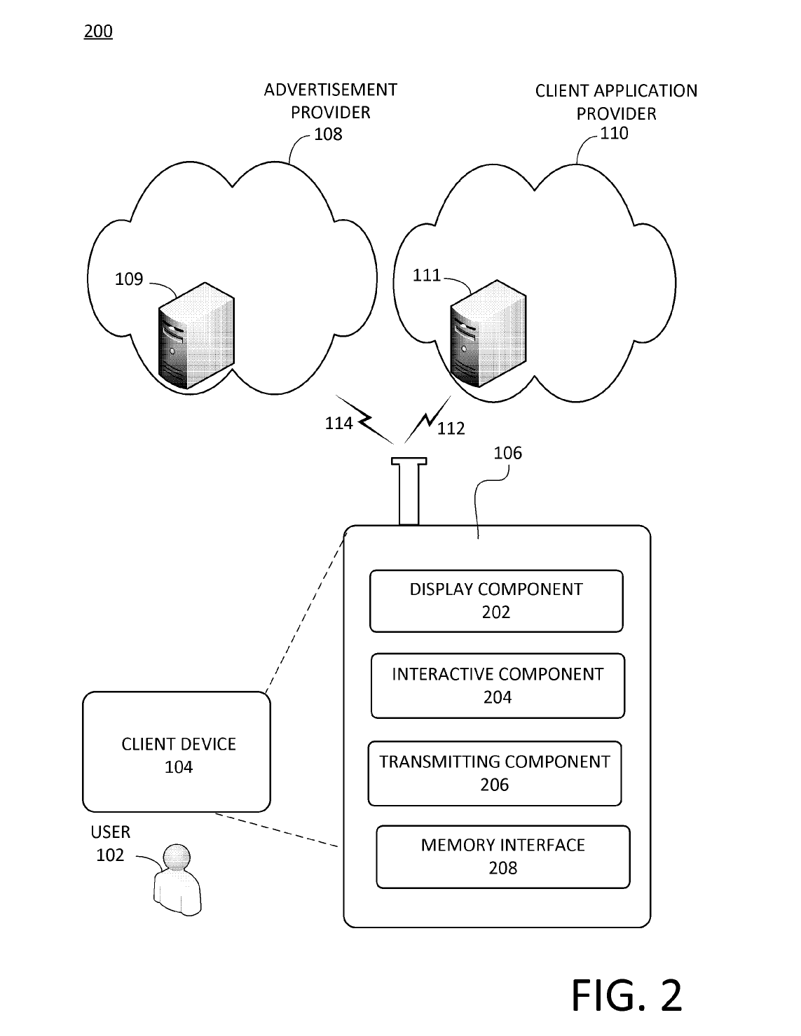

FIG. 2 shows an example configuration 200 of client application 106 by which at least portions of customizing advertisements in a mobile environment may be implemented, arranged in accordance with at least some embodiments described herein. As depicted, an example embodiment of client application 106, hosted on client device 104, may include a display component 202, an interactive component 204, a transmitting component 206, and a memory interface 208. In FIG. 2, client device 104 is depicted relative to advertisement provider 108 and client application provider 110, as in FIG. 1, along with the respective communication links 112 and 114 relative to client device 104; however, this configuration is an example only, and is not intended to be limiting in any manner. At least some embodiments of removing advertisements in a mobile environment may contemplate client application 106 implemented as a web browser that is configured to facilitate user interaction with at least advertisement provider 108, and/or client application provider 110.

Display component 202 may refer to a graphical component of client application 106 and may be displayed at a predetermined location (e.g., a lower portion) of a display screen of client device 104. Display component 202 may be configured to display a series of advertisements to user 102. Display component 202 may further facilitate user interaction with advertisement provider 108 by receiving input data and/or user interactions performed by user 102 on the display screen or a keyboard of client device 104. Further, when advertisements are stored locally, via memory interface 208 on a memory of client device 104, display component 202 may enable user interaction with the advertisements by allowing user 102 to perform user interactions e.g., a rubbing operation to remove the advertisements displayed via display component 202.

Display component 202 may be configured, designed, and/or programmed as a software module that resides, at least in part, on a memory of client device 104, and which may be executed by one or more processors on client device 104.

Interactive component 204 may refer to a component of client application 106 that is configured, designed, and/or programmed to detect one or more user interactions with client device 104, and to further remove, i.e., close or discontinue display of a displayed advertisement facilitated by display component 202, in response to at least one of the one or more detected user interactions.

Interactive component 204 may refer to a pop-up window or interactive widget configured to facilitate interaction with user 102. Accordingly, interactive component 204 may be configured, designed, and/or programmed as a software module that resides, at least in part, on a memory of client device 104, and which may be executed by one or more processors on client device 104.

Interactive component 204 may be configured, designed, or programmed to detect user interactions with client device 104, including but not limited to a user rubbing and/or swiping a finger across at least a portion of a display screen corresponding to client device 104. More particularly, the detected user interactions may include one or more fingers rubbing across a displayed advertisement. The rubbing operation of a user may imitate a physical wiping effect by one or more fingers of user 102 or by a pointer device (e.g., a wand) used by user 102. Detection of the rubbing is performed by detecting user contact on a portion of a screen of client device 104, on which client application 104 is hosted, that overlays at least one portion of the displayed one of the advertisements, and detecting continued user contact across at least a threshold distance across the displayed advertisement on the screen. The detection of continued user contact may be performed by determining whether a threshold frequency of “swipes,” or a threshold number of “swipes” within a certain amount of time has been met. The detection may be determined using a sensing device and a timing device, for example. The configuration is not limited to any particular sensing or timing devices and any suitable devices may be implemented. In accordance with at least one alternative embodiment, a dragging operation or other suitable operation may be performed to remove the advertisement. Dragging may be performed by a user selecting and contacting the displayed advertisement with at least one finger or a pointing device, and attempting to drag the displayed advertisement at least to a threshold boundary of the display screen of the client device 104.

Further still, user 102 may be required to answer at least one question, type a character or series of characters, enter a predetermined gesture, etc., in order to remove the advertisement. For example, in at least one embodiment, user 102 may be required to rate the product or services referenced in a displayed advertisement, or type a slogan or brand message of the company associated with the displayed advertisement. When user 102 inputs the required rating or slogan to interactive component 204, for example, the displayed advertisement maybe removed from display component 202.

Although implemented within a mobile environment, mobile advertising and customizing advertisements in accordance with embodiments described herein may also be implemented within web applications.

Interactive component 204 may be configured, designed or programmed to discontinue displaying at least one of the series of advertisements and extend a display of visual information, i.e., application window of client application 106 of client device 104, into the predetermined area of interactive component 204.

In one or more embodiments, interactive component 204 may be configured, designed or programmed to detect one or more other user interactions which may include inputting, via user 102, to the interactive component 204, information highlighted in the displayed one of the advertisements, to implement removal of the displayed advertisement. For example, the text of a displayed advertisement may include a company or brand name highlighted. The inputting operation may be implemented by receiving user input that includes the highlighted information at a predetermined area of interactive component 204. The highlighted information may include a word, phrase or symbol, or text specific to the advertisement, displayed to the user in the advertisement. To remove the advertisement, user 102 may input the displayed word, phrase or symbol on display component 202. User 102 may select highlighted information, by contacting the highlighted information with at least one finger, for example. When user 102 contacts the highlighted information, the displayed advertisement may be removed. Alternatively according to another embodiment, user 102 may select the highlighted information to remove the advertisement.

Interactive component 204 may be a text box that is configured, designed and/or programmed to include a text box to receive input. The text box may be an interactive pop-up window or an interactive widget. User 102 may input a displayed word, phrase, symbol rating information or company slogan or brand name using an inputting device, i.e., a keypad of client device 104, into the text box. Upon inputting the requested information, the displayed advertisement may be removed from display component 202.

Interactive component 204 may refer to a component of client application 106 that collects one or more previous user actions and transmits the one or more previous user actions to advertisement provider 108 for further processing and analysis. The one or more previous user actions may include user interaction with client device 104 detected and/or recorded over a predetermined amount of time. The user interaction may include at least one of a browsing history of user 102, time for which a previous advertisement was displayed, a recorded rate at which a displayed one of the advertisements was removed from display component 202, and/or a game playing history on the client device 104.

Transmitting component 206 may refer to a component of client application 106 that is configured, designed, and/or programmed transmit interactive information of user 102 from client device 104, on which client application 106 is hosted, to advertisement provider 108.

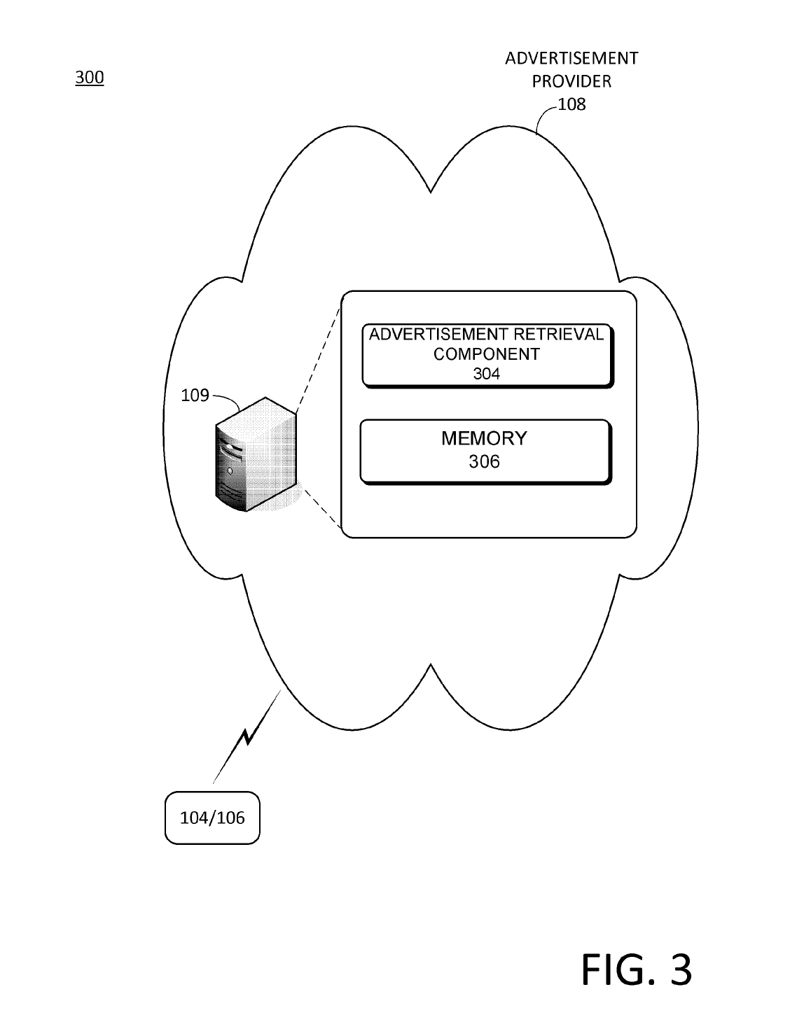

Memory interface 208 may refer to a storage or database hosted on, or otherwise associated with, client device 104. On client device 104, memory interface 208 may be configured, designed, and/or programmed to store one or more of the advertisements retrieved from server 109 of advertisement provider 108. Advertisements stored in memory interface 208 may be updated based on user interaction information received at advertisement provider 108 from client device 104, to tailor the advertisements based on the user interaction information transmitted. Server 109 may update the advertisements for retrieval via advertisement retrieval component 304 (referring to FIG. 3) based on the user interaction information and/or one or more previous user actions.

Thus, FIG. 2 shows an example configuration 200 by which one or more embodiments of mobile advertising and advertisement removal processes may be implemented.

FIG. 3 shows an example configuration 300 of an advertisement provider by which at least portions of customizing advertisements in a mobile environment may be implemented, arranged in accordance with at least some embodiments described herein. As depicted, example configuration 300 of advertisement provider 108 hosts server 109, which includes, at least, an advertisement retrieval component 304 and a memory 306; however, this configuration is an example only, and is not intended to be limiting in any manner.

Advertisement provider 108, as described with reference to FIG. 1, may be regarded as a cloud-based service and storage platform owned and/or operated by a third-party provider. Advertisement provider 108 may include a framework of hardware, software, firmware, or any combination thereof, through or to which digital advertisement data and information may be stored, passed, or shared for which client device 104 is a recipient. More particularly, cloud-based platform 108 may be implemented as a web-based storage and sharing service. Advertisement provider 108 may receive, from client device 104, user information collected at client device 104 under the control of user 102 as described below.

Advertisement retrieval component 304 may refer to a component of advertisement provider 108 that is configured, designed, and/or programmed to receive and process user information for advertisement retrieval, from client application 106, hosted on client device 104. The user information may include user context information including user interaction data, geographic information, demographic information, or running application information, for example. The user context information may be collected from mobile service subscription information corresponding to user 102 and actions performed by user 102 interacting with client device 104, e.g., browsing historical data. Advertisement retrieval component 304 may process user information by analyzing user information and selecting specific keyword information and other information to be used to perform advertisement retrieval. For example, specific keyword information may be selected from the browsing historical data e.g., real estate; alternatively, other information, e.g., age or gender, may be selected from mobile service subscription information corresponding to user 102.

Advertisement retrieval component 304 may be configured, designed, and/or programmed to perform an advertisement retrieval process using the user information. The retrieval process may be implemented by performing searches using existing searching technologies in information retrieval. For example, weighted keywords and semantic relevance gleaned from the user information may be used as a query to search for related advertisements from an advertisement-indexing system of the advertisement provider 108. The retrieved advertisements may be transmitted from advertisement provider 108 to client device 104, at which the retrieved advertisements may be stored via memory interface 208 associated with a memory of client device 104. The advertisement retrieval process may be performed regularly to correspond to changes in user context information and to update the stored advertisements via memory interface 208. According to one or more embodiments, the updating process may be performed during anticipated or detected non-use periods of client device 104.

According to one or more embodiments, a displayed advertisement may be removed from client device 104 via memory interface 208 when user 102 performs a removal process, e.g., user 102 rubs the displayed advertisement a threshold number of times. For example, if an advertisement is displayed on client device 104, and user 102 removes the displayed advertisement a predetermined number of times, e.g., at least 10 times, user interaction information associated with the displayed advertisement may be transmitted to the advertisement provider 108 via client application 106, and the stored advertisements of client device 104 may be updated accordingly.

Advertisement retrieval component 304 may be configured, designed, and/or programmed as a software module that resides, at least in part, on memory 306 and which may be executed by one or more processors on server 109.

Memory 306 may refer to a storage or database hosted on server 109. Memory 306 may be configured, designed, and/or programmed to store one or more advertisements that may be retrieved and displayed in accordance with embodiments described herein.

Thus, FIG. 3 shows an example configuration of advertisement provider 108 by which one or more embodiments of customizing advertisements in a mobile environment may be implemented.

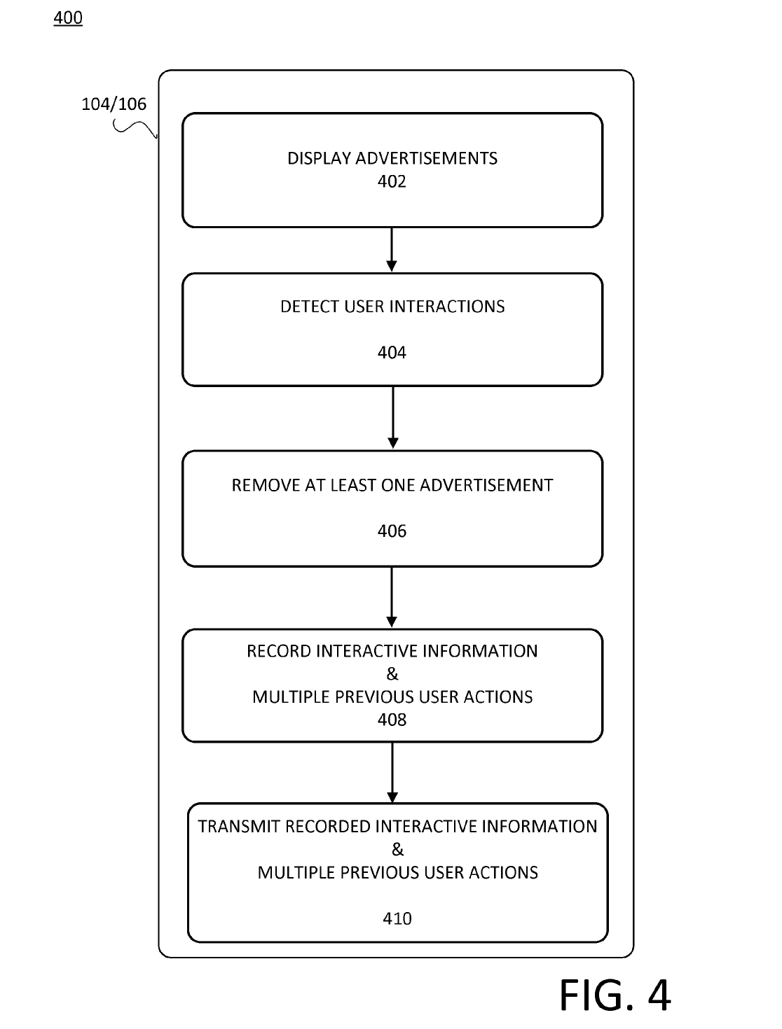

FIG. 4 shows an example processing flow 400 of operations for customizing advertisements implemented by client application, in accordance with at least some embodiments described herein. As depicted, processing flow 400 includes sub-processes executed by various components that are part of client device 104 hosted on client application 106. However, processing flow 400 is not limited to such components, as obvious modifications may be made by re-ordering two or more of the sub-processes described here, eliminating at least one of the sub-processes, adding further sub-processes, substituting components, or even having various components assuming sub-processing roles accorded to other components in the following description. Processing flow 400 may include various operations, functions, or actions as illustrated by one or more of blocks 402, 404, 406, 408 and/or 410. Processing may begin at block 402.

Block 402 (Display Advertisements) may refer to display component 302 receiving a series of advertisements from advertisement provider 108, via communication link 114. Processing may continue from block 402 to block 404.

Block 404 (Detect User Interactions) may refer to interactive component 204 detecting of one or more user interactions. The one or more user interactions may include rubbing across the displayed one of the advertisements, inputting one or more keywords corresponding to highlighted information. Processing may continue from block 404 to block 406.

Block 406 (Remove at Least One Advertisement) may refer to interactive component 204 removing the displayed advertisement from display component 302 in response to at least one of the one or more user interactions. Alternatively, removal of the advertisement may be performed by detecting, via the interactive component 204, inputted highlighted information of user 102 and removing the displayed advertisement from display component 302 in response to the detection. Processing may continue from block 406 to block 408.

Block 408 (Record Interactive Information and Multiple Previous User Actions) may refer to interactive component 204 collecting interactive information, i.e., one or more previous user actions, and storing the collected interactive information and one or more previous user actions via memory interface 308. The one or more previous user actions may include at least one of a browsing history of user 102, time for which a previous advertisement was displayed, a recorded rate at which a displayed one of the advertisements was removed from display component 302, and/or a game playing history on client device 104. Processing may continue from block 408 to block 410.

Block 410 (Transmit Recorded Interactive Information and Multiple Previous User Actions) may refer to transmitting component 306 transmitting user information for advertisement retrieval including the stored interactive information and one or more previous user actions to advertisement provider 108 for processing and analysis to customize the advertisements to be retrieved and displayed to user 102, such that the advertisements relate to the stored interactive information and user actions.

Thus, FIG. 4 shows an example processing flow executed by client application 106 of client device 104.

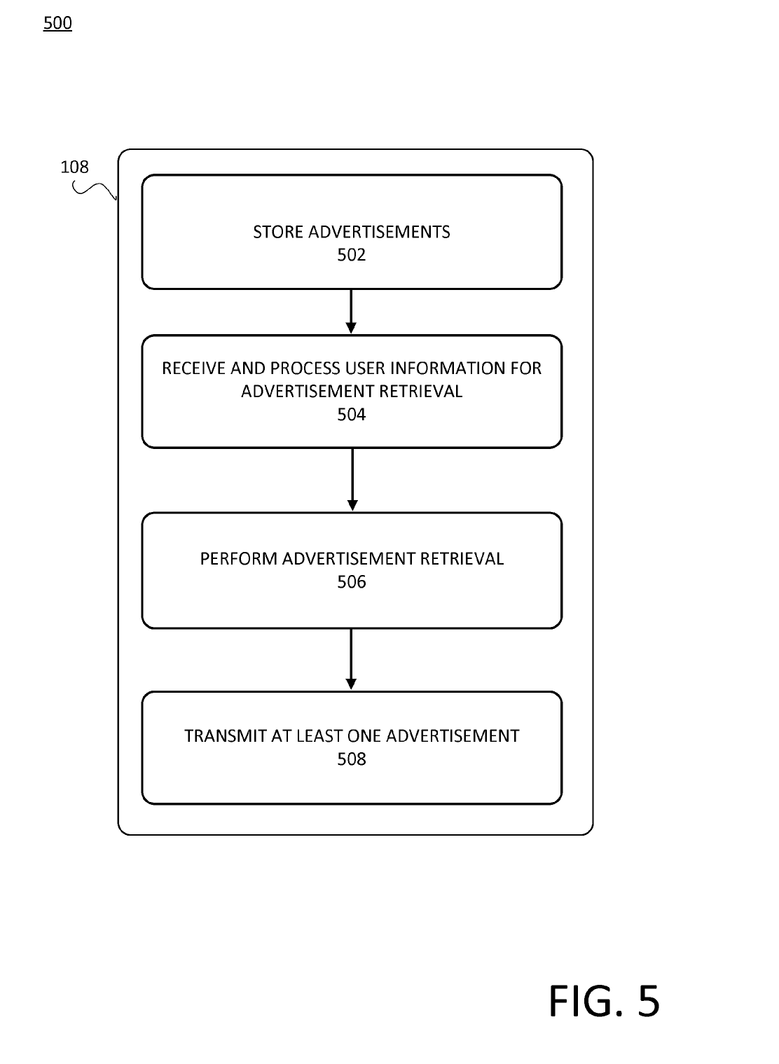

FIG. 5 shows an example processing flow 500 of operations for performing at least portions of customizing advertisements by an advertisement provider, in accordance with at least some embodiments described herein. As depicted, processing flow 500 includes sub-processes executed by various components that are part of advertisement provider 108. However, processing flow 500 is not limited to such components, as obvious modifications may be made by re-ordering two or more of the sub-processes described here, eliminating at least one of the sub-processes, adding further sub-processes, substituting components, or even having various components assuming sub-processing roles accorded to other components in the following description. Processing flow 500 may include various operations, functions, or actions as illustrated by one or more of blocks 502, 504, 506 and/or 508. Processing may begin at block 502.

Block 502 (Store Advertisements) may refer to memory 306 of server 209 storing advertisements received, e.g., from third party mobile advertisement subscribers. Processing may proceed from block 502 to block 504.

Block 504 (Receive and Process User Information for Advertisement Retrieval) may refer to advertisement retrieval component 304 receiving user information, from client device 104 via communication link 114, so that more relevant and/or desired advertisements may be sent to client device 104. The user information may include user context information, interactive information, and one or more previous user actions. Block 504 may further refer to advertisement retrieval component 304 processing the user information received via advertisement retrieval component 304. Advertisement retrieval component 304 may process user information by analyzing user information and selecting specific keyword information and other information to be used to perform advertisement retrieval. For example, specific keyword information may be selected from the browsing historical data, e.g., real estate, alternatively, other information, e.g., age or gender, may be selected from mobile service subscription information corresponding to user 102. Processing may continue from block 504 to block 506.

Block 506 (Perform Advertisement Retrieval) may refer to advertisement retrieval component 304 customizing advertisements in a mobile environment by performing an advertisement retrieval process using the user information. The retrieval process may be implemented by performing searching using existing searching technologies in information retrieval. For example, searching may be performed using weighted keywords and semantic gleaned from the user information as a query to search for related advertisements from an advertisement-indexing system, for example. The retrieval process may further include sorting through and selecting at least one advertisement stored in memory 306 based on the user information received. Processing may continue from block 506 to block 508.

Block 508 (Transmit At Least One Advertisement) may refer to advertisement provider 108 transmitting at least one advertisement retrieved from advertisement retrieval component 304 to client device 104.

Thus, FIG. 5 shows an example processing flow executed by advertisement provider 108 for implementing advertisement retrieval.

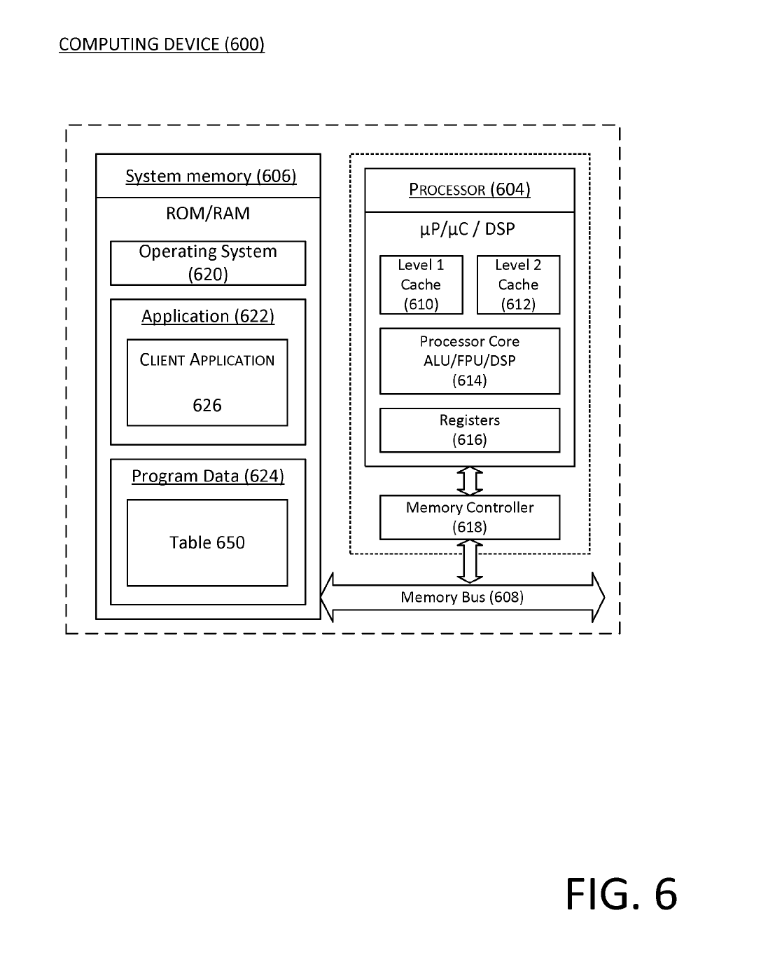

FIG. 6 shows a block diagram illustrating an example computing device 600 by which various example solutions described herein may be implemented, arranged in accordance with at least some embodiments described herein.

More particularly, FIG. 6 shows an illustrative computing embodiment, in which any of the processes and sub-processes described herein may be implemented as computer-readable instructions stored on a computer-readable medium. The computer-readable instructions may, for example, be executed by a processor of a device, as referenced herein, having a network element and/or any other device corresponding thereto, particularly as applicable to the applications and/or programs described above corresponding to the configuration 100 for performing mobile advertising and customizing advertisements in a mobile environment.

In a very basic configuration, a computing device 600 may typically include one or more processors 604 and a system memory 606. A memory bus 608 may be used for communicating between processor 604 and system memory 606.

Depending on the desired configuration, processor 604 may be of any type including but not limited to a microprocessor (μP), a microcontroller (μC), a digital signal processor (DSP), or any combination thereof. The processor 604 may include one or more levels of caching, such as a level one cache 610 and a level two cache 612, a processor core 614, and registers 616. An example processor core 614 may include an arithmetic logic unit (ALU), a floating point unit (FPU), a digital signal processing core (DSP Core), or any combination thereof. An example memory controller 618 may also be used with the processor 604, or in some implementations the memory controller 618 may be an internal part of the processor 604.

Depending on the desired configuration, system memory 606 may be of any type including but not limited to volatile memory (such as RAM), non-volatile memory (such as ROM, flash memory, etc.) or any combination thereof. System memory 606 may include an operating system 620, one or more applications 622 including client application 626, and program data 624.

Application 622 may be configured to transmit or receive identification information pertaining to client device 104, advertisement provider 108 or client application provider 110, verify or validate such identifying data, and transmit device data as described previously with respect to FIGS. 1 -5. Client application 626 may be implemented as client application provider 110, in whole or in part, as described previously with respect to FIG. 1, for example. Further, program data 624 may include a table 650, which may be useful for implementing actuation of appropriate components or modules as described herein.

System memory 606 is an example of computer storage media. Computer storage media may include, but not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by computing device 600. Any such computer storage media may be part of computing device 600.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

There is little distinction left between hardware and software implementations of aspects of systems; the use of hardware or software is generally (but not always, in that in certain contexts the choice between hardware and software can become significant) a design choice representing cost vs. efficiency tradeoffs. There are various vehicles by which processes and/or systems and/or other technologies described herein may be implemented, e.g., hardware, software, and/or firmware, and that the preferred vehicle may vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the devices and/or processes for system configuration 100 via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers, e.g., as one or more programs running on one or more computer systems, as one or more programs running on one or more processors, e.g., as one or more programs running on one or more microprocessors, as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors, e.g., feedback for sensing position and/or velocity; control motors for moving and/or adjusting components and/or quantities. A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Lastly, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

1. An apparatus, comprising:
a display component configured to display a series of advertisements; and
an interactive component configured to:
detect one or more user interactions, wherein the one or more user interactions include rubbing across the displayed one of the advertisements, the rubbing being detected by:
detecting user contact on a portion of a screen of a device, on which the apparatus is hosted, that overlays at least a portion of the displayed one of the advertisements; and
detecting continued user contact across at least a threshold distance across the screen, and
remove a displayed one of the advertisements from the display component in response to at least one of the one or more user interactions.

2. (canceled)

3. (canceled)

4. The apparatus of claim 1, wherein the interactive component is further configured to:
collect one or more previous user actions; and
transmit the one or more previous user actions to a server.

5. The apparatus of claim 1, wherein the one or more of user interactions comprise inputting, to the interactive component, information highlighted in the displayed one of the advertisements.

6. The apparatus of claim 5, wherein the inputting comprises:
highlighting information on the displayed one of the advertisements;
receiving user input at a predetermined area of the interactive component; and
receiving further user input that includes the highlighted information.

7. The apparatus of claim 6, wherein the interactive component is further configured to:
discontinue displaying at least one of the series of advertisements; and
extend a display of visual information into the predetermined area.

8. The apparatus of claim 1, further comprising a transmitting component configured to: transmit interactive information from the device on which the apparatus is hosted to a server, wherein the interactive information includes a recorded rate at which the displayed one of the advertisements was removed from the display component.

9. The apparatus of claim 4, wherein the server updates the series of advertisements to be displayed by the display component based on the transmitted one or more previous user actions.

10. The apparatus of claim 8, wherein the server updates the series of advertisements to be displayed by the display component based on the transmitted interactive information.

11. A method, comprising:
displaying a series of advertisements;
removing at least one of the series of advertisements in response to at least one of one or more user interactions, wherein at least one of the one or more user interactions includes rubbing across the displayed one of the advertisements;
recording one or more previous user actions; and
transmitting the recorded one or more previous user actions to a server.

12. (canceled)

13. The method of claim 11, wherein the removing comprises detecting the rubbing, which includes:
detecting user contact on a portion of a screen of a device that overlays at least a portion of the displayed one of the advertisements; and
detecting continued user contact across at least a threshold distance across the screen.

14. The method of claim 11, further comprising:
discontinuing displaying the series of advertisements; and
extending a display of visual information into a predetermined area.

15. The method of claim 11, further comprises transmitting interactive information from a device on which the method is performed to a server, the interactive information including recorded rates at which a user has removed at least one of the series of advertisements.

16. The method of claim 11, wherein the server updates the series of advertisements to be displayed based on the transmitted one or more previous user actions.

17. The method of claim 15, wherein the server updates the series of advertisements to be displayed based on the transmitted interactive information.

18. (canceled)

19. (canceled)

20. (canceled)

21. (canceled)

22. A system, comprising:
a server configured to maintain an advertisement database; and
a device, communicatively connected to the server, configured to display a series of advertisements that are removable in response to one or more user interactions,
wherein the device hosts on an instance of an application that is configured to:
record user interaction with the device;
transmit the recorded user interaction to the server; and
receive, from the server, at least one advertisement selected in accordance with the recorded user interaction.

23. The system of claim 22, wherein the application downloads the series of advertisements from the advertisement database on the server.

24. The system of claim 23, wherein the device has a screen configured to respond to the one or more user interactions that include rubbing across the displayed one of the series of advertisements.

25. The system of claim 23, wherein each of the series of advertisements includes highlighted information.

26. The system of claim 25, wherein the device is configured to respond to the one or more user interactions that include inputting one or more keywords corresponding to the highlighted information.

27. (canceled)

28. The system of claim 22 wherein the application is configured to record the user interaction with the device over a predetermined amount of time.

29. The system of claim 28, wherein the recorded user interaction includes at least one of a browsing history, time for which a previous advertisement was displayed, and a game playing history.
